(19) United States
(12) Patent Application Publication
(10) Pub. No.: US 2014/0223906 A1
(43) Pub. Date: Aug. 14, 2014

(54) SOLAR/GAS HYBRID POWER SYSTEM CONFIGURATIONS AND METHODS OF USE

(71) Applicant: SkyFuel, Inc., Arvada, CO (US)

(72) Inventors: Randall C. GEE, Arvada, CO (US); David WHITE, Denver, CO (US)

(21) Appl. No.: 13/763,332

(22) Filed: Feb. 8, 2013

(51) Int. Cl. F03G 6/06; F01K 23/10

(52) U.S. Cl. CPC F03G 6/064; F01K 23/10
USPC 60/641.15; 60/641.1

(57) ABSTRACT

Solar/gas hybrid concentrating solar power (CSP) systems and methods of using the CSP systems are described. The hybrid CSP systems are highly efficient due, at least in part, to a solar segment comprising a first heat transfer fluid and a thermal storage segment comprising a second heat transfer fluid. The second heat transfer fluid heat exchanges with a steam segment to produce steam that drives a steam turbine. Thus, the solar and thermal segments perform the “heavy lifting” of producing steam from water. Once the steam is produced, it enters a superheater of the steam segment. The superheater, which does not heat exchange directly with the thermal storage segment, is heated by a gas turbine positioned downstream from the thermal storage segment.

### CROSS-REFERENCE TO RELATED APPLICATIONS

None.

### BACKGROUND

This invention is in the field of solar/gas hybrid power systems, and relates to system configurations and methods of operation designed to optimize the solar-generated fraction of power produced by the hybrid systems.

Solar/gas hybrid power systems use both solar energy and energy liberated by the combustion of natural gas to generate electricity. By combining solar thermal energy and natural gas combustion, solar/gas hybrid systems offer a practical and efficient approach to deploying solar energy in power generation markets. However, solar/gas hybrid plants have previously either used natural gas with poor efficiency or required that the amount of solar energy be relatively small (e.g., under 15%) compared to the natural gas contribution.

In one type of known solar/gas hybrid system, natural gas is used to warm a heat transfer fluid (HTF) within the solar field when solar energy is not available in the desired amount. As shown in FIG. 1, an auxiliary boiler combusts natural gas to heat the HTF to a temperature ranging from 350° C. to 390° C., which is then used to make superheated steam that drives a steam turbine to generate electricity. This system uses natural gas less efficiently than it could be used in a modern stand-alone combined cycle plant.

In another solar/gas hybrid system (illustrated in FIG. 4), natural gas is used to operate a gas turbine that generates electricity, and waste heat from the gas turbine is used to produce superheated steam that operates a steam turbine to generate additional electricity. The gas turbine is sized so that it produces enough exhaust heat to operate the steam turbine. During sunlight hours when the solar collector field operates, solar generated steam is combined with the exhaust heat from the gas turbine to generate even more electricity. This Integrated Solar Combined Cycle (ISCC) system uses natural gas efficiently, but limits the contribution from solar energy to about 15%. If more than this amount of solar steam (typically heated to about 330° C. to 370° C.) is produced by the solar field, the exhaust gases from the gas turbine are no longer able to superheat the (now larger) amount of steam to the design inlet temperature needed by the steam turbine (typically 500° C.+), thereby reducing steam turbine efficiency. Since high cycle efficiency is required both when solar steam is available and when it is not, the amount of added solar steam must be small. Also, note that the ISCC approach relies on gas-firing of the plant during all daylight hours to avoid wasting solar-generated steam. If the plant's operational schedule results in non-operation during sunlit hours, any solar-generated steam cannot be used, and the collected solar energy is wasted.

Another solar/gas hybrid design has recently been proposed in which exhaust heat from a gas turbine directly heats the solar field HTF. Like the ISCC, the proposed system contains two types of turbines: a gas-fired turbine and a steam turbine, but the gas turbine capacity is small relative to the steam turbine capacity. (See e.g., Turchi, C. S.; Ma, Z. and Erbes, M. “Gas Turbine/Solar Parabolic Trough Hybrid Designs”, NREL, ASME TurboExpo 2011, Jun. 6-10, 2011.) The proposed system uses an aeroderivative gas turbine with exhaust temperatures ranging from about 415° C. to 515° C. The exhaust heat from a 40 MW gas turbine is used to heat the HTF to 395° C., matching the solar field exit temperature. Thus, the gas turbine exhaust heats the HTF to the same temperature as the solar field, so “looks” like additional solar collectors to the steam/power generation equipment. The solar fraction of the proposed system (illustrated in FIG. 2) is reported to be 57% with a high gas usage efficiency that rivals a combined cycle plant. This type of hybrid system also has a lower installed cost than a comparable solar-only plant, and results in a higher conversion efficiency of solar energy to electricity. However, it requires either off-design lower-performance operation of the gas turbine or operation of the gas turbine at full output and dumping/wasting some thermal energy when the solar plus waste heat total exceeds the steam turbine capacity.

To potentially avoid dumping/wasting thermal energy, a thermal energy storage (TES) system could be incorporated into a hybrid design. FIG. 3 shows a typical concentrated solar power (CSP) system configuration incorporating indirect two-tank TES. In this configuration, stored heat suffers two heat exchanger (HX) temperature drops: one when the heated fluid is charged and placed into the hot tank, and then a second when the heated fluid is discharged from the hot tank. During thermal storage discharge, the supply temperature to the steam generator can be 15° C. to 20° C. below the solar field outlet temperature. This large temperature drop results in part load operation (e.g. 90%) of the steam turbine whenever storage is discharged.

A number of patents and publications have discussed the benefits and drawbacks of known solar thermal power systems. See for example, Kelly, B. and Kearney, D. “Thermal Storage Commercial Plant Design Study for a 2-Tank Indirect Molten Salt System: Final Report”, National Renewable Energy Laboratory, NREL/SR-550-40166, July 2006; Denholm, P. and Mehos, M., “Tradeoffs and Synergies between CSP and PV at High Grid Penetration”, NREL, July 2011; Mills, A. and Wiser, R., “Changes in the Economic Value of Variable Generation at High Penetration Levels: A Pilot Case Study of California”, LBNL-5445E, June 2012; Turchi, C. S. and Ma, Z., “Gas Turbine/Solar Parabolic Trough Hybrid Design Using Molten Salt Heat Transfer Fluid”, NREL, SolarPACES 2011, Sep. 20-23, 2011; Turchi, C.; Mehos, M.; Ho, C. K.; and Kolb, G. J., “Current and Future Costs for Parabolic Trough and Power Tower Systems in the US Market”, NREL, SolarPACES 2010, Sep. 21-24, 2010; Turchi, C. S.; Ma, Z. and Erbes, M. “Gas Turbine/Solar Parabolic Trough Hybrid Designs”, NREL, ASME TurboExpo 2011, Jun. 6-10, 2011; U.S. Pat. No. 8,286,429 entitled “Solar Hybrid Combined Cycle Gas and Steam Power Plant”; German Patent Application No. 20 2008 002 599 U1; U.S. Patent Application Publication No. 2011/0131989 entitled “Supplemental Working Fluid Heating to Accommodate Variations in Solar Power Contributions in a Concentrated Solar-Power Enabled Power Plant”; and U.S. Patent Application Publication No. 2012/0102950 entitled “Solar Thermal Power Plant with the Integration of an Aeroderivative Turbine”.

### SUMMARY

The present invention provides solar/gas hybrid concentrating solar power (CSP) systems that use both natural gas and concentrated solar thermal energy to provide electricity. The solar/gas hybrid configurations described herein comprise three segments: a solar segment, a thermal storage segment, and a water/steam segment that incorporates waste heat from a gas turbine. Each of these segments is physically isolated from the other segments. The hybrid CSP systems are highly efficient due, at least in part, to a solar segment comprising a first heat transfer fluid and a thermal segment comprising a second heat transfer fluid. The second heat transfer fluid heat exchanges with a steam segment to produce steam that drives a steam turbine. Thus, the solar and thermal segments perform the “heavy lifting” of producing steam from water. Once the steam is produced, it enters a superheater of the steam segment. The superheater, which does not heat exchange directly with the thermal storage segment, is heated by a gas turbine positioned downstream from the thermal storage segment.

A gas turbine/solar trough hybrid configuration (illustrated in FIG. 5) is described herein that incorporates thermal energy storage (TES) in which the solar heat is used for steam generation and exhaust heat from a gas turbine is used to superheat the solar-generated steam. This solar/gas hybrid system is designed to keep the operation of both turbines (the gas turbine and the steam turbine) at, or very near, their design points, which maximizes efficiencies and also uses the exhaust heat from the gas turbine to superheat the steam in order to maximize the cycle efficiency of the steam turbine. The TES provides a thermal energy “buffer”. Energy from a storage tank is withdrawn only when it is capable of producing sufficient steam to operate the steam turbine at (or near) its design point. The gas turbine runs at its design capacity whenever energy is being withdrawn from storage (e.g., two-tank storage or thermocline TES). Just one or two hours of TES is sufficient to maintain operation at the design points of the two turbines, and also eliminates dumped/wasted energy. Without TES, energy must be dumped/wasted at times when the solar segment is producing more energy than the steam turbine can accept. TES provides a place for the excess solar heat to be stored, so the excess heat is not wasted.

As illustrated in FIG. 5, heat from the solar troughs is stored within a thermal storage segment so that when heat is withdrawn from the thermal storage segment it can generate steam within the water/steam segment. Exhaust heat from the gas turbine superheats the solar-generated steam. The use of gas turbine exhaust for superheat increases the cycle efficiency of the steam turbine. With saturated steam provided by the solar segment, and superheat provided by the gas turbine exhaust, the turbine inlet temperature can be increased above the solar field exit temperature. With the 450° C. exhaust temperature of a typical gas turbine, the steam turbine cycle efficiency can be increased from about 37% to at least 39%. This improves the solar-to-electricity conversion, and also the conversion efficiency of the exhaust heat from the gas turbine to electricity.

Further, the molten salt supply temperature to the steam boiler is substantially steady, unlike with the traditional indirect two-tank system configuration (illustrated in FIG. 3) in which energy from storage is delivered at a reduced temperature. This means that energy from storage is not disadvantaged compared to energy coming directly from a solar field. Also, a heat exchange temperature drop penalty is incurred only once for stored energy within a directly configured storage system, not twice as with the conventional indirect two-tank molten salt configurations.

The solar/gas hybrid system design described herein provides dispatchable power in a thermally efficient way and consumes natural gas more effectively than prior solar/gas hybrids when operating at a high solar fraction. The steam turbine and gas turbine both operate at their design output levels, and the use of a gas turbine for steam superheating increases conversion efficiencies. The solar/gas hybrid system described herein allows operation at full capacity during early evening (on-peak) hours, and use of TES eliminates any dumped energy from the solar field. The solar-to-molten salt heat exchanger temperature drop penalty is only incurred once, and the solar/gas hybrid power system allows for high solar fractions.

Temperatures, pressures, and flow rates, as well as gas turbine selections, solar multiples, and TES sizes may be varied and/or optimized according to the needs of a particular system. There are also some modifications to the system configuration that are available, such as adding the capability of heating the hot tank and/or feedwater with gas turbine exhaust.

In some embodiments, the solar contribution provides the dominant portion of the energy (i.e., greater than 50% of the electricity produced by the system is provided by solar energy). The amount of thermal energy required to produce saturated steam (i.e., the heat of vaporization) is in general significantly larger than the amount of thermal energy required to superheat the saturated steam for efficient use in a steam turbine. For example, at a steam pressure of 1500 psia, the heat of vaporization is 1170 Btu per pound, while superheating the saturated steam another 100° C. (e.g., 313° C. to 413° C.) requires only an addition of 176 Btu per pound. So, in this specific example, only 13% of the total amount of energy is used for superheating, and this energy is obtained from the exhaust heat of the gas turbine. For this reason, solar/gas hybrid power systems disclosed herein may have high solar contributions and small natural gas contributions. In some embodiments, the solar contribution will generally be above 60%, in some embodiments above 65%, in some embodiments above 70%, in some embodiments above 75%, and in some embodiments above 80%.

In an aspect, a hybrid concentrated solar power (CSP) system comprises a solar segment comprising at least one solar reflector optically coupled to a first conduit for a first heat transfer fluid; a thermal storage segment configured to store solar heat energy produced by the solar segment; wherein the thermal storage segment comprises a second conduit for a second heat transfer fluid; a steam segment configured to receive the solar heat energy stored by the thermal storage segment and to generate electric power when steam from the steam segment operates a steam turbine; and a gas turbine configured to generate electric power and to exhaust heat to a superheater of the steam segment, wherein the superheater does not heat exchange directly with the thermal storage segment.

In an embodiment, a solar segment is a concentrating solar array, or a concentrating solar reflector, or one or more parabolic concentrating solar devices.

In some embodiments, the fluids of the solar segment, thermal storage segment and/or steam segment of the hybrid CSP system are thermally coupled (e.g., by way of a heat exchanger) but physically isolated from one another. Thus, the first heat transfer fluid and the second heat transfer fluid are generally in thermal contact and physically isolated from one another, and the second heat transfer fluid and the steam are generally in thermal contact and physically isolated from one another.

Thermal contact may be provided, in some embodiments, by a heat exchanger configured to transfer energy between the physically isolated segments of the hybrid CSP system. For example, a heat exchanger may be configured to transfer solar heat energy between the solar segment and the thermal storage segment, or to transfer energy stored in the thermal storage segment to the steam segment.

Selection of first and second heat transfer fluids having appropriate freezing points, boiling points, heat capacity, viscosity, corrosivity, cost, stability, and availability are important to the operation of the hybrid CSP systems.

In a typical hybrid CSP system of the present invention, the first heat transfer fluid has a different composition than the second heat transfer fluid. In some embodiments, the first heat transfer fluid is selected from the group consisting of water, molten salt, Therminol® VP-1, oils, and combinations thereof. In an embodiment, the molten salt HTF may be a salt or salt blend selected from the group consisting of NaCl, KCl, NaNO₃, KNO₃, CaCl₂, Ca(NO₃)₂ and combinations thereof. For example, in an embodiment, the molten salt HTF may be a ternary blend, such as a blend of approximately 7% NaNO₃, 45% KNO₃ and 48% Ca(NO₃)₂ with a melting point near 120° C.

In some embodiments, the second heat transfer fluid is selected from the group consisting of molten salt, Therminol® VP-1, oils, and combinations thereof. In an embodiment, the molten salt HTF may be a salt or salt blend selected from the group consisting of NaCl, KCl, NaNO₃, KNO₃, CaCl₂, Ca(NO₃)₂ and combinations thereof. For example, in an embodiment, the molten salt HTF may be a ternary blend, such as a blend of approximately 7% NaNO₃, 45% KNO₃ and 48% Ca(NO₃)₂ with a melting point near 120° C.

Therminol® VP-1 is a synthetic vapor phase/liquid phase heat transfer fluid with a vapor phase operating temperature range of 257° C. to 400° C., and a liquid phase operating temperature range of 12° C. to 400° C. Therminol® VP-1 is a eutectic mixture of 73.5% diphenyl oxide and 26.5% biphenyl. It can be used as a liquid heat transfer fluid or as a boiling-condensing heat transfer fluid up to its maximum use temperature, and it is miscible with other similarly constituted diphenyl-oxide/biphenyl fluids. The properties of VP-1 are further described in the product literature, available at www.therminol.com/pages/products/vp-1.asp, accessed Oct. 16, 2012, which is expressly incorporated by reference herein.

Molten salt is a non-toxic, readily available material that retains thermal energy effectively over time and can operate at temperatures greater than 550° C., which matches well with the most efficient steam turbines. For comparison, oil has a maximum temperature of about 400° C. Molten salt also costs a fraction (e.g., 1/10^{th}) of what traditional HTFs, such as synthetic oils, cost. However, oil is preferred as the HTF for use in a parabolic trough solar collection field because molten salt has a high freezing point, and energy is required to prevent it from freezing at night. (T. Price, “Molten Salt: The Magic Ingredient?” CSP Today, Nov. 6, 2009, available at social.csptoday.com/technology/molten-salt-magic-ingredient accessed Jan. 6, 2013.) The high freezing point of molten salt HTFs has dissuaded many from designing solar/gas hybrid power systems requiring constant motion of a liquid molten salt HTF without a heating apparatus (e.g., an auxiliary boiler or gas turbine) for warming the HTF.

In an embodiment, the maximum temperature of the first heat transfer fluid is less than 450° C., or less than 425° C., or less than 400° C., or less than 385° C. For example, the maximum temperature of the first heat transfer fluid may be selected from the range of 350° C. to 450° C., or selected from the range of 385° C. to 425° C.

In an embodiment, the maximum temperature of the second heat transfer fluid is less than 565° C., or less than 525° C., or less than 500° C., or less than 475° C., or less than 442° C., or less than 425° C. For example, the temperature of the second heat transfer fluid may be selected from the range of 400° C. to 565° C., or selected from the range of 425° C. to 550° C., or selected from the range of 425° C. to 500° C.

It will be understood that regardless of the maximum available operating temperatures of the first and second HTFs, in a properly functioning hybrid CSP system the temperature of the first HTF must be higher than the temperature of the second HTF for energy to flow from the solar segment to the thermal storage segment. In an embodiment, a difference in temperature between the first heat transfer fluid as it exits the solar reflector and the second heat transfer fluid is selected from the range of 8° C. to 40° C., or selected from the range of 10° C. to 30° C., or selected from the range of 12° C. to 25° C.

There will also be a temperature drop as energy is transferred from the thermal storage segment to the steam segment. In an embodiment, a difference in temperature between the second heat transfer fluid and the steam prior to superheating by the exhaust heat of the gas turbine is greater than or equal to 10° C.

During operation, the pressure of superheated steam entering the steam turbine is greater than 650 psia (45 bar), or greater than 800 psia, or greater than 1000 psia, or greater than 1250 psia, or greater than 1500 psia. For example, the pressure of the steam may be selected from the range of 650 psia to 1600 psia, or selected from the range of 800 psia to 1500 psia, or selected from the range of 1000 psia to 1250 psia.

In an embodiment, cycle efficiency of a steam turbine is increased about 5% when the steam turbine is operated at a temperature of 425° C. compared to operating the steam turbine at 375° C.

In an embodiment, the solar reflector is a linear parabolic reflector.

In an embodiment, the thermal storage segment comprises at least one storage tank for storing the second heat transfer fluid, and in an embodiment, the storage tank may be in a direct configuration with the second conduit. In most embodiments, the second conduit is cyclical such that it forms a continuous circuit. In an embodiment, the storage tank is a single-tank thermocline energy storage subsystem. In another embodiment, the storage tank is selected from the group consisting of a hot tank and a cold tank; typically both a hot tank and a cold tank are present. For example, a hot tank may have a size capable of holding sufficient thermal energy to operate the steam turbine for at least 30 minutes, or at least 60 minutes, or at least 120 minutes, or at least 180 minutes. A cold tank will typically have a size capable of holding the entire volume of the second heat transfer fluid once the hot tank is emptied, such that all the second heat transfer fluid is contained in the cold tank.

The steam segment of the present hybrid CSP systems comprises a superheater for receiving exhaust heat directly from a gas turbine. In some embodiments, the superheater is directly thermally coupled with the gas turbine, but not with the thermal storage segment. The steam segment receives solar heat energy stored by the thermal storage segment through a steam generator or through a steam generator and a solar preheater.

The steam segment further comprises a condenser for recycling the steam as it exits the steam turbine. Water exiting the condenser is heated by a feedwater heater, and the feedwater heater may be heated by a source selected from the group consisting of exhaust heat from said gas turbine, said solar heat energy from said solar segment, said solar heat energy from said thermal storage segment and combinations of these.

The gas turbine of the present hybrid CSP systems may, in some embodiments, be an aeroderivative gas turbine. The gas turbine is, in most embodiments, configured to exhaust heat to a superheater of the steam segment. Thus, in some embodiments, the thermal storage segment of the hybrid CSP system is upstream from the gas turbine. However, the gas turbine may, in some embodiments, be additionally configured to exhaust heat to a storage tank. In some embodiments, a hybrid CSP system may comprise a second gas turbine configured to exhaust heat to the thermal storage segment.

In an embodiment, exhaust gas from the natural gas turbine has a temperature selected over the range of 350° C. to 650° C., in some embodiments selected over the range of 400° C. to 650° C., and in some embodiments selected over the range of 460° C. to 600° C.

In an embodiment, the average fraction of energy produced by solar gain is at least 50%, or at least 60%, or at least 70%, or at least 80%, or at least 85%, or at least 90%. For example, the average fraction of energy produced by solar gain may be selected from the range of 50% to 90%, or selected from the range of 60% to 90%, or selected from the range of 70% to 90%, or selected from the range of 80% to 90%.

In an embodiment, a hybrid CSP power system of the present invention has an electricity production capacity selected from the range of 5 MW to 250 MW, or selected from the range of 25 MW to 150 MW, or selected from the range of 50 MW to 100 MW.

In an embodiment, a hybrid CSP power system includes a gas turbine and a steam turbine, where a ratio of the capacity of the gas turbine to the capacity of the steam turbine is between 1:10 and 3:10. Generally, the capacity of the gas turbine is less than the capacity of the steam turbine. For example, the capacity of the gas turbine may be at least three times less than the capacity of the steam turbine, in some embodiments, at least five times less than the capacity of the steam turbine, and in some embodiments, at least ten times less than the capacity of the steam turbine.

In an aspect, a method for producing electricity from a hybrid CSP system comprises the steps of: collecting solar heat energy using a solar segment comprising at least one solar reflector optically coupled to a first conduit for a first heat transfer fluid; thermally coupling the solar segment to a thermal storage segment configured to store the solar heat energy produced by the solar segment; wherein the thermal storage segment comprises a second conduit for a second heat transfer fluid; transferring the solar heat energy stored in the thermal storage segment to a steam segment configured to receive the solar heat energy; generating electric power using steam from the steam segment to operate a steam turbine; and generating electric power from a gas turbine to supplement the electric power produced by the steam turbine, wherein the gas turbine is configured to exhaust heat to the steam segment. In an embodiment, the step of thermally coupling comprises exchanging heat between the first heat transfer fluid and second heat transfer fluid.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### REFERENCES

1) Kelly, B. and Kearney, D. “Thermal Storage Commercial Plant Design Study for a 2-Tank Indirect Molten Salt System: Final Report”, National Renewable Energy Laboratory, NREL/SR-550-40166, July 2006
2) Denholm, Paul and Mehos, Mark, “Tradeoffs and Synergies between CSP and PV at High Grid Penetration”, NREL, July 2011
3) Mills, A. and Wiser, R., “Changes in the Economic Value of Variable Generation at High Penetration Levels: A Pilot Case Study of California”, LBNL-5445E, June 2012
4) Ma, Z. and Erbes, M. “Gas Turbine/Solar Parabolic Trough Hybrid Designs”, NREL, ASME TurboExpo 2011, Jun. 6-10, 2011

### BRIEF DESCRIPTION OF THE FIGURES

FIG. 1 provides a schematic of a prior art CSP system that uses an auxiliary boiler to combust natural gas and warm a heat transfer fluid (HTF) within the solar field when sunlight is not available in the desired amount.

FIG. 2 provides a schematic of a prior art solar/gas hybrid system in which exhaust heat from a gas turbine directly heats the solar field HTF.

FIG. 3 provides a schematic of a prior art non-hybrid concentrated solar power (CSP) system configuration incorporating indirect two-tank TES.

FIG. 4 provides a schematic of a prior art solar/gas hybrid system, often referred to as an Integrated Solar Combined Cycle (ISCC) system.

FIG. 5 provides a schematic of a solar/gas hybrid power system with a solar segment, a thermal storage segment, and a water/steam segment that incorporates the waste heat from a gas turbine, according to an exemplary embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of the invention.

A “concentrated solar power (CSP)” system uses mirrors, lenses or reflectors to concentrate or focus sunlight onto a small area. The focused solar energy is converted to heat, which is used to produce steam that drives a steam turbine, to produce electricity.

A “hybrid CSP system”, as used herein, is a CSP system that integrates at least two sources of energy, solar energy and at least a secondary energy source that is a non-solar energy source. In some embodiments, the secondary energy source may not directly produce electricity (e.g., the secondary energy source may heat a HTF that provides thermal energy for electricity production). In another embodiment, the secondary energy source may directly produce electricity. For example, the secondary energy source may fuel an electricity-producing component, such as a gas turbine. In an embodiment, the hybrid CSP system may be a Rankine-Brayton system, particularly, a natural gas/solar system.

A “component” is used broadly to refer to an individual part of a system. For example, a gas turbine, a parabolic trough or a solar segment may be a component of a hybrid CSP system.

The terms “directly and indirectly” describe the actions or physical positions of one component relative to another component. For example, a component that “directly” acts upon or touches another component does so without intervention from an intermediary. Contrarily, a component that “indirectly” acts upon or touches another component does so through an intermediary (e.g., a third component).

A “maximum temperature” of a heat transfer fluid is an operating temperature. For example, the maximum temperature may be the operating temperature achieved at the highest electricity production capacity of the system, or the maximum temperature may be an optimal operating temperature for a component of a hybrid CSP system. Generally, the maximum temperature is a temperature that the system does not exceed during operation, for example, to preserve the mechanical integrity of the system and to ensure safety. In one embodiment, a maximum temperature of a heat transfer fluid is a temperature below a phase transition temperature of the heat transfer fluid, e.g., below a boiling point of the heat transfer fluid.

Hybrid CSP systems and methods of making and using the systems will now be described with reference to the figures. For clarity, multiple items within a figure may not be labeled and the figures may not be drawn to scale.

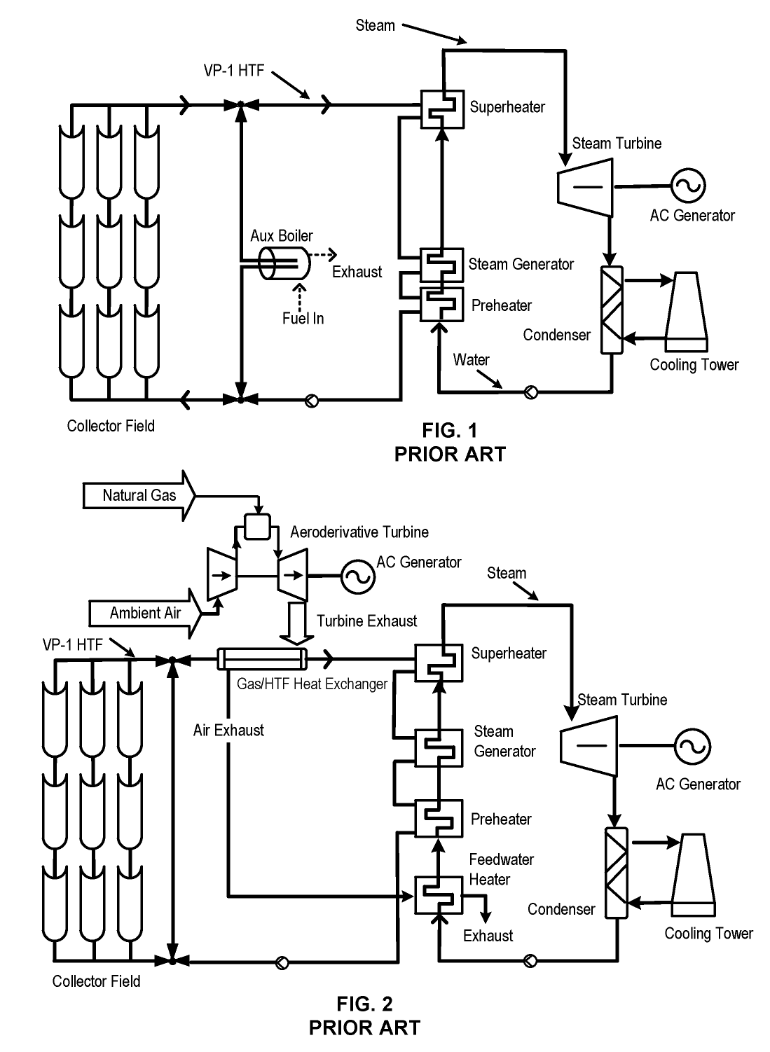

FIG. 1 provides a schematic of a prior art concentrated solar power (CSP) system that uses an auxiliary boiler to combust natural gas to warm a heat transfer fluid (HTF) within the solar collector field when sunlight is not available in the desired amount. The system contains a solar segment and a steam segment, but there is no thermal storage capacity in the configuration of FIG. 1. The HTF of the solar segment, a synthetic oil (VP-1), circulates from a series of parabolic troughs toward a heat exchanger coupled to a superheater of the steam segment, which contains a steam turbine for generating electricity. As steam exits the steam turbine, it enters a condenser/cooling tower where it is converted to water that is cycled or pumped to a preheater and a steam generator that heat exchange with the HTF as it circulates in a countercyclical direction relative to the flow of water/steam.

FIG. 2 provides a schematic of a prior art solar/gas hybrid system in which exhaust heat from a gas turbine directly heats the solar field HTF. The system contains a solar segment and a steam segment, but no thermal storage capacity. A synthetic oil HTF (VP-1) circulates through a series of parabolic troughs then through a gas/HTF heat exchanger that receives exhaust heat from a natural gas turbine that generates electricity. The HTF then heat exchanges with a superheater, steam generator and preheater of the steam segment. Steam from the superheater drives a steam turbine that produces electricity. Steam exiting the turbine enters a condenser/cooling tower where it is converted to water which cycles or is pumped to a feedwater heater. The feedwater heater is heated by exhaust from the gas/HTF heat exchanger. The water from the feedwater heater is fed to the preheater, steam generator and superheater in a countercyclical direction relative to the flow of the HTF.

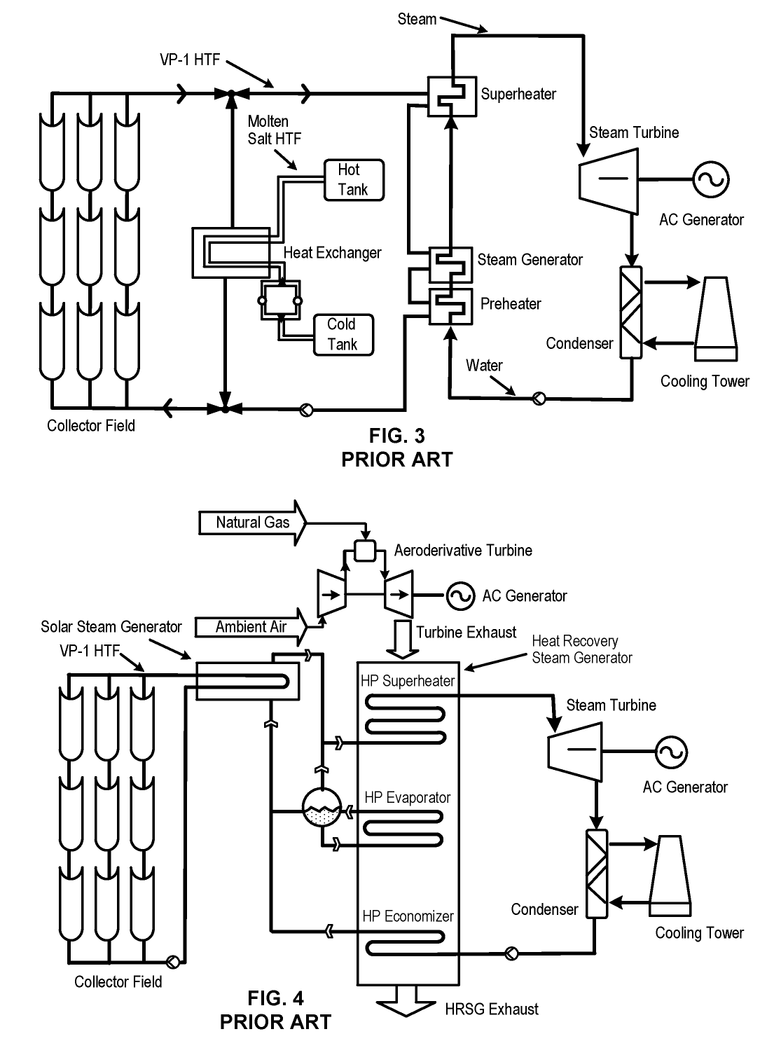

FIG. 3 provides a schematic of a prior art non-hybrid concentrated solar power (CSP) system incorporating indirect two-tank TES. A synthetic oil HTF (e.g., VP-1) is warmed by a series of parabolic troughs. The oil HTF is then either pumped directly to a steam segment, where it heat exchanges with steam in a superheater, or diverted by a 3-way valve to “charge” a thermal storage segment. The thermal storage segment includes a hot tank and a cold tank for storing a molten salt HTF. The hot and cold tanks are positioned at opposite ends of a non-cyclical conduit (i.e., they are not in a conduit loop). The thermal storage segment is “charged” when the molten salt HTF is transferred from the cold tank to the hot tank through an oil-to-salt heat exchanger that is warmed by the oil HTF from the parabolic troughs. The thermal storage segment is “discharged” by transferring molten salt HTF from the hot tank to the cold tank, thereby reheating the oil HTF, which is transferred to the steam segment. In this system, the molten salt HTF of the thermal storage segment need not be in motion for heat to be transferred to the steam segment. For example, the HTF may be held in the hot tank until it is needed. When molten salt HTF stored in the hot tank is needed (e.g., during nighttime hours) to warm the oil HTF that is heat exchanging with steam in the steam segment, the molten salt HTF is pumped out of the hot tank to the cold tank through the oil-to-salt heat exchanger. The oil HTF is heated by this “discharge” process, and pumped toward the superheater of the steam segment. Thus, the HTFs are heat exchanged twice (once during charging and once during discharging) in the indirect two-tank TES configuration. Steam within the steam segment drives a steam turbine that produces electricity. Steam exiting the turbine enters a condenser/cooling tower and is converted to water that enters a preheater and steam generator before re-entering the superheater.

FIG. 4 provides a schematic of a prior art hybrid system that is commonly referred to as an Integrated Solar Combined Cycle (ISCC) system. The ISCC system has a solar segment comprising a plurality of parabolic troughs. Synthetic oil HTF (e.g., VP-1) circulates through the solar segment and heat exchanges with a solar steam generator that supplies steam to a superheater allocated within a heat recovery steam generator (HRSG). A natural gas turbine (e.g., an aeroderivative turbine) produces electricity by combustion of natural gas, and exhaust or waste heat from the turbine is directed through the HRSG, which contains a superheater, evaporator and economizer. Steam from the superheater drives a steam turbine that produces electricity. The ISCC system can operate without any solar input, using exclusively natural gas, or it can operate using natural gas plus solar heat. Steam exiting the steam turbine enters a condenser/cooling tower and is converted into water. The water enters the economizer, for preheating then flows to the solar steam generator.

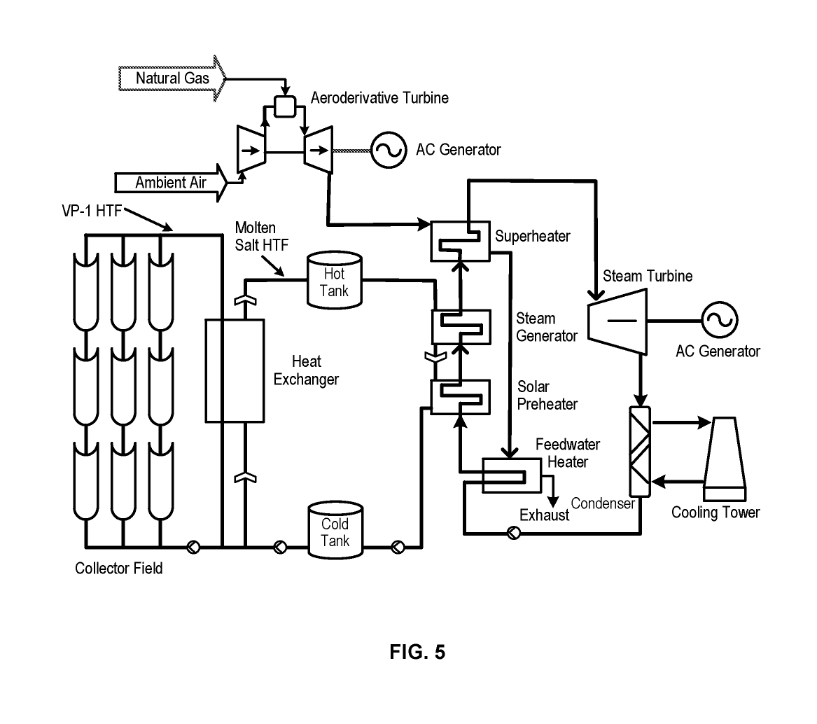

FIG. 5 provides a schematic of a solar/gas hybrid power system with a solar segment, a thermal storage segment, and a water/steam segment that incorporates the waste heat from a gas turbine, according to an exemplary embodiment. A solar segment includes a collector field made up of a plurality of parabolic troughs connected in series and/or parallel by cyclical conduits containing a synthetic oil HTF (e.g., VP-1). The oil HTF heat exchanges with a molten salt HTF of a thermal storage segment by way of an oil-to-salt heat exchanger. In this system, unlike in the indirect storage system, there is no way to directly heat the steam segment using the oil HTF. In an embodiment, the thermal storage segment contains a cyclical conduit having at least one storage tank in a direct configuration. The thermal storage tank may, for example, be a hot tank, a cold tank or a thermocline tank. In the embodiment shown in FIG. 5, the thermal storage segment may be operated as a continuous flow loop wherein molten salt HTF exiting the heat exchanger flows to a hot tank, then to one or more heat exchangers coupled to a steam segment, followed by a cold tank and back to the oil-to-salt heat exchanger. In this operational mode, the molten salt HTF used within the thermal storage segment is in motion throughout the entire thermal storage segment conduit. This enables heat to be transferred from the solar segment to the thermal storage segment while simultaneously transferring heat from the thermal storage segment to the water/steam segment.

Other operational modes exist. For example, when there is no solar collection (such as at night), but the hot tank still contains some hot molten salt HTF, the molten salt HTF can be pumped from the hot tank for heat exchange with the water/steam segment to make steam. In this operational mode, the amount of molten salt HTF decreases in the hot tank and increases in the cold tank. Of course, this operational mode must end once the hot tank is empty.

Another operational mode can occur when there is solar collection within the solar segment but it is not desirable to generate steam or make electricity. As long as the hot tank is not full, molten salt HTF can be pumped from the cold tank, heated via exchange with the oil/salt heat exchanger, and then stored within the hot tank. In this operational mode the molten salt is not simultaneously pumped from the hot tank for heat exchange with the water/steam segment, so no steam is made and no electricity is generated.

The solar/gas hybrid power system configuration of FIG. 5 also includes a natural gas turbine (e.g., an aeroderivative turbine) that produces electricity from the combustion of fossil fuel. Waste heat from the gas turbine is thermally coupled to a superheater of a steam segment. Superheated steam drives a steam turbine that produces electricity, and steam exiting the steam turbine enters a condenser/cooling tower where it is converted into water. The water enters a feedwater heater, followed by a solar preheater and a steam generator which both heat exchange with the thermal storage segment.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, and method steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individually or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A hybrid concentrated solar power (CSP) system comprising:
a solar segment comprising at least one solar reflector optically coupled to a first conduit for a first heat transfer fluid;
a thermal storage segment configured to store solar heat energy produced by said solar segment; wherein said thermal storage segment comprises a second conduit for a second heat transfer fluid;
a steam segment configured to receive the solar heat energy stored by the thermal storage segment and to generate electric power when steam from the steam segment operates a steam turbine; and
a gas turbine configured to generate electric power and to exhaust heat to a superheater of said steam segment, wherein the superheater does not heat exchange directly with the thermal storage segment.

2. The hybrid CSP system of claim 1, wherein said thermal storage segment is upstream from said gas turbine.

3. The hybrid CSP system of claim 1, wherein said first heat transfer fluid and said second heat transfer fluid are in thermal contact and are physically isolated from one another.

4. The hybrid CSP system of claim 1, wherein said second heat transfer fluid and said steam are in thermal contact and are physically isolated from one another.

5. The hybrid CSP system of claim 1, further comprising a heat exchanger configured to transfer solar heat energy between the solar segment and the thermal storage segment.

6. The hybrid CSP system of claim 1, wherein said first heat transfer fluid is selected from the group consisting of water, molten salt, Therminol® VP-1, oils and combinations thereof.

7. The hybrid CSP system of claim 1, wherein said second heat transfer fluid is selected from the group consisting of molten salt, Therminol® VP-1, oils and combinations thereof.

8.-16. (canceled)

17. The hybrid CSP system of claim 1, wherein said solar reflector is a linear parabolic reflector.

18. The hybrid CSP system of claim 1, wherein said thermal storage segment comprises a storage tank for storing said second heat transfer fluid.

19.-23. (canceled)

24. The hybrid CSP system of claim 1, wherein a feedwater heater is heated by a source selected from the group consisting of exhaust heat from said gas turbine, said solar heat energy from said solar segment, said solar heat energy from said thermal storage segment and combinations of these.

25. The hybrid CSP system of claim 1, wherein said gas turbine is an aeroderivative gas turbine.

26. The hybrid CSP system of claim 1, wherein said gas turbine is further configured to exhaust heat to said storage tank.

27. The hybrid CSP system of claim 1, further comprising a second gas turbine configured to exhaust heat to said thermal storage segment.

28. The hybrid CSP system of claim 1, wherein the heat exhausted by the gas turbine has a temperature selected from the range of 410° C. to 600° C.

29.-31. (canceled)

32. A method for producing electricity from a hybrid CSP system, said method comprising the steps of:
collecting solar heat energy using a solar segment comprising at least one solar reflector optically coupled to a first conduit for a first heat transfer fluid;
thermally coupling said solar segment to a thermal storage segment configured to store said solar heat energy produced by said solar segment; wherein said thermal storage segment comprises a second conduit for a second heat transfer fluid;
transferring said solar heat energy stored in said thermal storage segment to a steam segment configured to receive said solar heat energy;
generating electric power using steam from the steam segment to operate a steam turbine; and
generating electric power from a gas turbine to supplement the electric power produced by said steam turbine, wherein said gas turbine is configured to exhaust heat to said steam segment.

33. The method of claim 32, wherein said thermal storage segment is upstream from said gas turbine.

34. The method of claim 32, wherein said step of thermally coupling comprises exchanging heat between said first heat transfer fluid and second heat transfer fluid.

35. (canceled)

36. The method of claim 32, wherein said thermal storage segment further comprises at least one storage tank for storing said second heat transfer fluid.

37.-39. (canceled)

40. The method of claim 32, wherein the maximum temperature of said second heat transfer fluid is less than 442° C.

41.-43. (canceled)

44. The method of claim 32, wherein the heat exhausted by the gas turbine has a temperature selected from the range of 460° C. to 600° C.

45.-47. (canceled)
